(19) United States
(12) Patent Application Publication
(10) Pub. No.: US 2006/0126537 A1
(43) Pub. Date: Jun. 15, 2006

(54) System and method to connect devices to a network via a network learning and programming remote control

(76) Inventor: Cory J. Booth, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/009,104

(22) Filed: Dec. 10, 2004

(51) Int. Cl. H04L 12/28

(52) U.S. Cl. 370/255

(57) ABSTRACT

A method and system for connecting devices to a network via a network learning and programming remote control have been described. The method includes requesting network information via a remote control from an access point for a network, where the network information is required for a device to access the network and providing the network information to the device via the remote control, where the device is capable of using the network information to access the network.

### BACKGROUND

The importance for the consumer electronic device industry to continuously strive to produce devices that are convenient to use cannot be overstated. No doubt this is one of the reasons for making devices that can be connected to one's home or office wireless network. But, the ease of connecting a device to a wireless network often correlates to a person's understanding of how his or her network operates.

Currently, users have to connect a device manually to a wireless network which requires them to select and input a variety of information, including the SSID (network name), channel number and wireless network encryption information. Unfortunately, many people do not have an accurate mental model of how wireless networks work, do not know their SSID or channel number, and have a difficult time inputting and understanding wireless encryption. This process is even more daunting when one tries to connect a new device such as a digital media adapter to a wireless network. Here, the network's information must be inputted into the digital media adapter via a remote control. In addition, the process of inputting complex information into a television user-interface is difficult due to the low resolution of the television screen.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for connecting a device to a network via a network learning and programming remote control, in which some embodiments of the present invention may operate;

FIG. 2 illustrates an example remote control with network learning and programming functionalities according to an embodiment of the invention;

FIG. 3 is a flow diagram of one embodiment of a process for the operation of connecting a device to a network via a network learning and programming remote control;

FIG. 4 is a flow diagram of one embodiment of a process for executing the network learning functionality of the present invention; and

FIG. 5 is a flow diagram of one embodiment of a process for executing the network programming functionality of the present invention.

### DESCRIPTION OF EMBODIMENTS

A method and system for connecting devices to a network via a network learning and programming remote control are described. Here, at least some of the problems described above may be alievated by automating the process for a user to connect a device to a network without having to know the network SSID, channel number, network encryption information and any other network information or settings required by a device to access the network. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

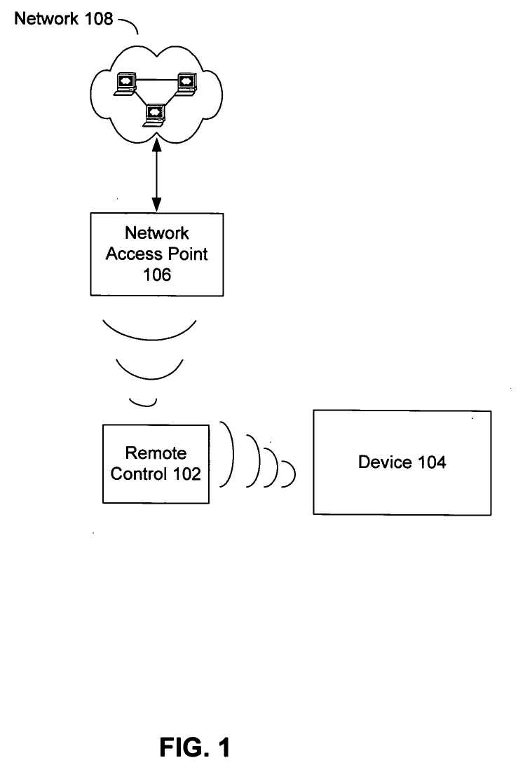

FIG. 1 illustrates one embodiment of an environment for connecting a device to a network via a network learning and programming remote control, in which some embodiments of the present invention may operate. The specific components shown in FIG. 1 represent one example of a configuration that may be suitable for the invention and is not meant to limit the invention.

Referring to FIG. 1, the environment for connecting a device to a network via a network learning and programming remote control may include, but is not necessarily limited to, a remote control 102, a device 104, a network access point 106 and a network 108. Remote control 102 includes functionality to learn information/settings required to access network 108 and functionality to provide the learned network information/settings to device 104, although the invention is not limited in this regard. In an embodiment of the invention, device 104 is a wireless device capable of accessing network 108. Network access point 106 is any connection point for network 108. In an embodiment of the invention, a user may use the ‘learn network’ functionality of remote control 102 to request network information or settings from network access point 106. The network information is necessary for device 104 to access network 108. The user may then use the ‘program network’ functionality of remote control 102 to provide the network information to device 104. Device 104 may then use the network information to gain access to network 108. Each of these components will be described next in more detail.

Network 108 may be a wireless local area network (WLAN) and/or wireless wide area network (WWAN) such as the global system for mobile communication (GSM) and/or wireless universal serial bus (wireless USB), to name a few examples. However, the invention is not limited in this regard and contemplates any wireless or non-wireless network capable of communicating and/or conveying network information to remote control 102.

Remote control 102 includes functionality to learn information required to access network 108 and functionality to provide the learned network information to device 104. Remote control 102 may be implemented as a traditional (infrared) IR remote control, a personal digital assistant (PDA), a laptop, a mobile phone, a personal computer, and so forth, that is modified to include the network learning and programming functionalites of the invention. These example implementations of remote control 102 are provided for illustration purposes only and are not meant to limit the invention.

As described above, device 104 may be any device capable of accessing network 108 via access point 106. Examples of device 104 may include, but are not limited to, a digital media adapter (DMA), a laptop, a personal computer, a personal digital assistant (PDA), a mobile phone, a media center, a television, a digital video disk (DVD) player, a video cassette recorder (VCR) player, a compact disk (CD) player, a set-top box, a stereo receiver, a personal video recorder (PVR), a MP3 player and so forth.

As described above, network access point 106 is any connection point for network 108. Access point 106 may be implemented as a wireless router or as a computer with wireless router capabilities, although the present invention is not limited in this regard. Access point 106 may be a hotspot that provides public wireless broadband network services to mobile visitors through a WLAN or may be a hotspot that provides access to a private home or office network.

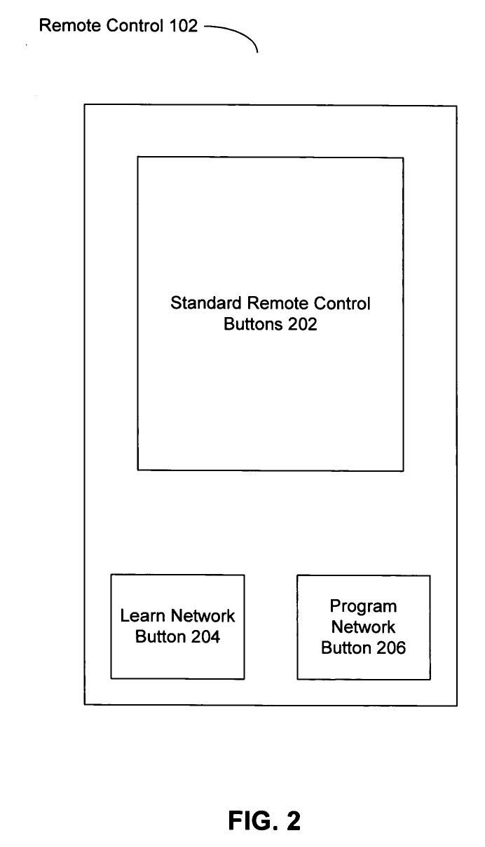

FIG. 2 illustrates an example remote control with network learning and programming functionalities according to an embodiment of the invention. The example remote control of FIG. 2 is shown for illustrative purposes only and is not meant to limit the invention. Referring to FIG. 2, example remote control 102 includes one or more standard remote control buttons 202 that may include buttons such as power on/off, volume up/down, channel up/down, etc. Remote control 202 may also include a learn network button 204 and a program network button 206. It is important to note that buttons 204 and 206 may be hard or soft buttons (e.g., via a liquid crystal display (LCD) touch screen on a PDA, mobile phone, etc.), depending on the implementation of remote control 102. In an implementation of the invention, the user could access a setup menu in remote control 102 where learn network button 204 and program network button 206 are available. Once the user utilizes buttons 204 and 206 to allow device 104 access to network 108, buttons 204 and 206 may be replaced by other buttons that are more closely related to the task the user is performing, or the device the user is accessing, at any given time. Embodiments of the operation of the present invention are described next in more detail.

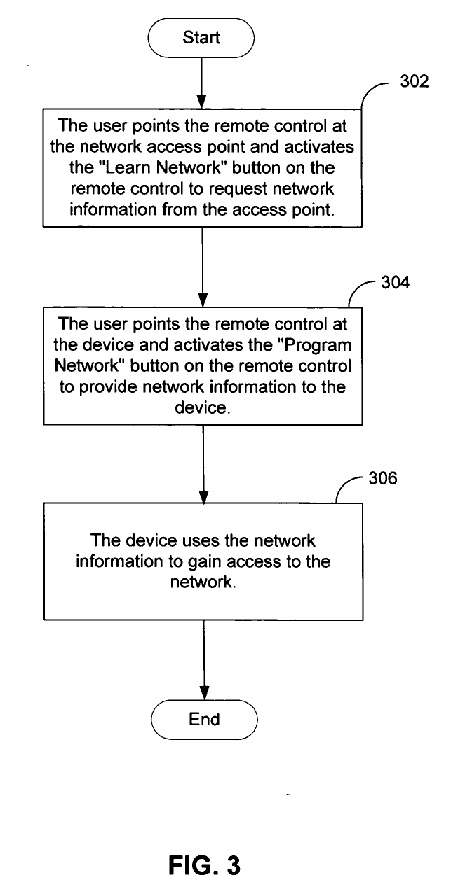

Operations for the above system may be further described with reference to the following FIGS. 3-5 and accompanying examples. In addition, the given operation may be implemented by a hardware element, a software element executed by a processor, or any combination thereof. The embodiments are not limited in this context.

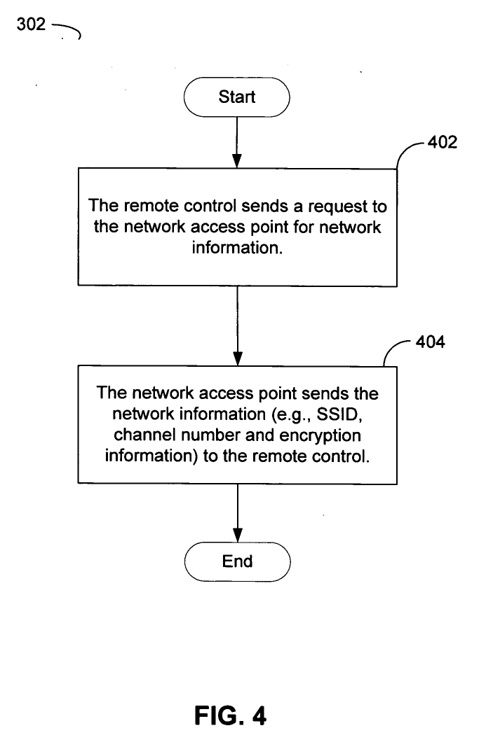

FIG. 3 is a flow diagram of one embodiment of a process for the operation of connecting a device to a network via a network learning and programming remote control. Referring to FIG. 3, the process begins at processing block 302 with the user pointing a remote control (such as remote control 102 of FIG. 1) at a network access point (such as access point 106 of FIG. 1) and activating a Learn Network Button (such as learn network button 204 of FIG. 2) on the remote control. When the Learn Network Button is activated, the remote control sends a request to the network access point (such as access point 106 of FIG. 1) for network information and settings. As described above, the network information and settings may include information necessary for a device (such as device 104 of FIG. 1) to access the network. Processing block 302 is described in more detail below with reference to FIG. 4.

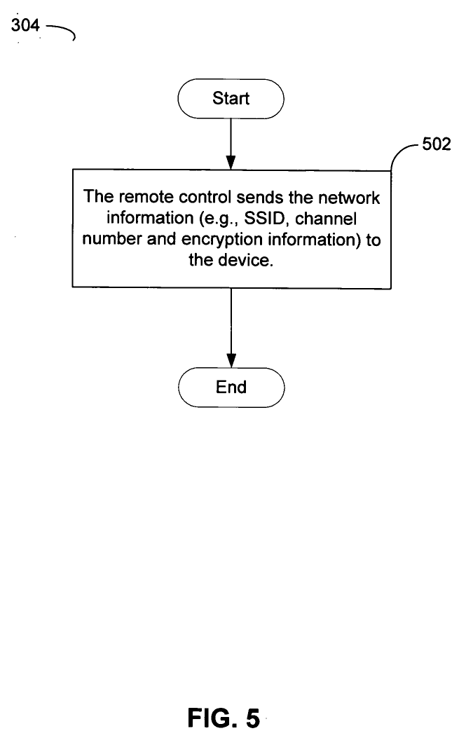

The user then points the remote control at the device and activates the Program Network Button (such as program network button 206 of FIG. 2) to provide network information to the device at processing block 304. Processing block 304 is described in more detail below with reference to FIG. 5.

In an embodiment of the invention, the transmittal of the network information both from the network access point to the remote control in block 302 and from the remote control to the device in block 304 are accomplished via a near-field communication. The near-field communication may be implemented via infrared technology, Bluetooth technology, radio frequency technology, or a similar near-field communication technology.

At processing block 306, the device uses the provided network information to gain access to the network. The flow diagram of FIG. 3 ends at this point.

FIG. 4 is a flow diagram of one embodiment of a process for executing the network learning functionality of the present invention (block 302 of FIG. 3). Referring to FIG. 4, the process begins with the remote control sending a request to the network access point for network information/settings at processing block 402. Then, at processing block 404, the network access point sends the network information (e.g., SSID, channel number and encryption information) to the remote control. The flow diagram of FIG. 4 ends at this point.

FIG. 5 is a flow diagram of one embodiment of a process for executing the network programming functionality of the present invention (block 304 of FIG. 3). Referring to FIG. 5, the process begins with the remote control sending the network information to the device. The flow diagram of FIG. 5 ends at this point.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
requesting network information via a remote control from an access point for a network, wherein the network information is required for a device to access the network; and
providing the network information to the device via the remote control, wherein the device is capable of using the network information to access the network.

2. The method of claim 1, wherein a user may request the network information by activating a learn network function on the remote control and wherein the user may provide the network information to the device by activating a program network function on the remote control.

3. The method of claim 2, wherein the remote control is one of an infrared (IR) remote control, a personal digital assistant (PDA), a laptop, a mobile phone and a personal computer, wherein the IR remote control, the PDA, the laptop, the mobile phone and the personal computer are capable of performing the learn network function and the program network function.

4. The method of claim 1, wherein the network information is provided from the access point to the remote control and then from the remote control to the device via a near-field communication.

5. The method of claim 4, wherein the near-field communication may be implemented via infrared technology, Bluetooth technology or radio frequency technology.

6. The method of claim 1, wherein the network is a wireless network.

7. The method of claim 1, wherein the network is a wired network.

8. The method of claim 1, wherein the device is a wireless device and is one of a digital media adapter (DMA), a laptop, a personal computer, a personal digital assistant (PDA), a mobile phone, a media center, a television, a digital video disk (DVD) player, a video cassette recorder (VCR) player, a compact disk (CD) player, a set-top box, a stereo receiver, a personal video recorder (PVR) and a MP3 player.

9. A method comprising:
requesting network information via a remote control from an access point for a network, wherein the network information is required for a device to access the network, wherein a user may request the network information by activating a learn network function on the remote control and wherein the network information is provided from the network access point to the remote control via a near-field communication; and
providing the network information to the device via the remote control, wherein the device is capable of using the network information to access the network, wherein the user may provide the network information to the device by activating a program network function on the remote control and wherein the network information is provided from the remote control to the device via the near-field communication.

10. The method of claim 9, wherein the network is a wireless network.

11. The method of claim 9, wherein the network is a wired network.

12. A remote control comprising:
a learn network function; and
a program network function,
wherein the learn network function is capable of requesting network information from an access point for a network, wherein the network information is required for a device to access the network; and
wherein the program network function is capable of providing the network information to the device, wherein the device is capable of using the network information to access the network.

13. The remote control of claim 12, wherein the remote control is one of an infrared (IR) remote control, a personal digital assistant (PDA), a laptop, a mobile phone and a personal computer, wherein the IR remote control, the PDA, the laptop, the mobile phone and the personal computer are capable of performing the learn network function and the program network function.

14. The remote control of claim 12, wherein the network information is provided from the access point to the remote control and then from the remote control to the device via a near-field communication.

15. The remote control of claim 14, wherein the near-field communication may be implemented via infrared technology, Bluetooth technology or radio frequency technology.

16. The remote control of claim 12, wherein the network is a wireless network.

17. The remote control of claim 12, wherein the network is a wired network.

18. The remote control of claim 12, wherein the device is a wireless device and is one of a digital media adapter (DMA), a laptop, a personal computer, a personal digital assistant (PDA), a mobile phone, a media center, a television, a digital video disk (DVD) player, a video cassette recorder (VCR) player, a compact disk (CD) player, a set-top box, a stereo receiver, a personal video recorder (PVR) and a MP3 player.

19. A machine-readable medium containing instructions which, when executed by a processing system, cause the processing system to perform a method, the method comprising:
requesting network information via a remote control from an access point for a network, wherein the network information is required for a device to access the network; and
providing the network information to the device via the remote control, wherein the device is capable of using the network information to access the network.

20. The machine-readable medium of claim 19, wherein a user may request the network information by activating a learn network function on the remote control and wherein the user may provide the network information to the device by activating a program network function on the remote control.

21. The machine-readable medium of claim 20, wherein the remote control is one of an infrared (IR) remote control, a personal digital assistant (PDA), a laptop, a mobile phone and a personal computer, wherein the IR remote control, the PDA, the laptop, the mobile phone and the personal computer are capable of performing the learn network function and the program network function.

22. The machine-readable medium of claim 19, wherein the network information is provided from the access point to the remote control and then from the remote control to the device via a near-field communication.

23. The machine-readable medium of claim 22, wherein the near-field communication may be implemented via infrared technology, Bluetooth technology or radio frequency technology.

24. The machine-readable medium of claim 19, wherein the network is a wireless network.

25. The machine-readable medium of claim 19, wherein the network is a wired network.

26. The machine-readable medium of claim 19, wherein the device is a wireless device and is one of a digital media adapter (DMA), a laptop, a personal computer, a personal digital assistant (PDA), a mobile phone, a media center, a television, a digital video disk (DVD) player, a video cassette recorder (VCR) player, a compact disk (CD) player, a set-top box, a stereo receiver, a personal video recorder (PVR) and a MP3 player.
